(19) United States
(12) Patent Application Publication
(10) Pub. No.: US 2025/0234866 A1
(43) Pub. Date: Jul. 24, 2025

(54) DISINFECTANT-DOSING MICROGEL AND METHOD OF USING THE SAME

(71) Applicant: THE HONG KONG UNIVERSITY OF SCIENCE AND TECHNOLOGY, KOWLOON (CN)

(72) Inventors: KING LUN YEUNG, HONG KONG (CN); KA KIT CHENG, HONG KONG (CN); LONG TING LUK, HONG KONG (CN)

(73) Assignee: THE HONG KONG UNIVERSITY OF SCIENCE AND TECHNOLOGY, KOWLOON (CN)

(21) Appl. No.: 19/176,580

(22) Filed: Apr. 11, 2025

Related U.S. Application Data
(62) Division of application No. 17/465,911, filed on Sep. 3, 2021.

(51) Int. Cl. A01N 59/16; A01N 25/04; A01N 25/08; A01N 25/10; A01N 31/08; A01N 33/12; A01N 37/04; A01N 59/00; A01N 59/02; A01N 59/20; A01P 1/00

(52) U.S. Cl. CPC A01N 59/16; A01N 25/04; A01N 25/08; A01N 25/10; A01N 31/08; A01N 33/12; A01N 37/04; A01N 59/00; A01N 59/02; A01N 59/20; A01P 1/00

(57) ABSTRACT

The disinfectant-dosing microgel is formed from a mixture of a sol and a solution of a disinfecting and deodorizing agent. In use, the sol phase is transformed, by various conditions, into an active microgel. The disinfectant-dosing microgel is applied to the waste, such as by spraying, mixture therewith or the like. The combination of the sol and the solution of the disinfecting and deodorizing agent or, alternatively, the combination of the polymer and the solution of the disinfecting and deodorizing agent, is triggered to transform from the sol phase into the active microgel for long-term disinfection and deodorization of the waste by the temperature, pH, and/or salt concentration of the waste. The transformation to the active microgel for long-term disinfection and deodorization of the waste can also be initiated by adding chemical substances to alter the pH or promote gelation, either before, during or after application to the waste.

### CROSS-REFERENCE TO RELATED APPLICATION

This application is a divisional application of U.S. patent application Ser. No. 17/465,911, filed on Sep. 3, 2021, which claimed the benefit of U.S. Provisional Patent Application No. 63/204,036, filed on Sep. 8, 2020.

### BACKGROUND

### 1. Field

The disclosure of the present patent application relates to waste treatment, and particularly to a microgel with sustained release of disinfecting and deodorizing compounds for application to waste.

### 2. Description of the Related Art

A wide range of disinfectants are known to disinfect and decrease the viability and activity of microorganisms in the environment and, particularly, in waste. Examples of such disinfecting substances include sodium chlorite, sodium hypochlorite, potassium peroxymonosulfate, quarternary ammonium compounds and the like. Similarly, a wide variety of relatively basic and common substances are known for their odor controlling properties, such as calcium, copper, iron, and other metal salts, as well as magnesium, sodium hydroxide and sodium nitrite. However, the usefulness of such compounds for both disinfection and deodorizing is limited, given that they are typically only active at the time of application, with their effectiveness very rapidly diminishing thereafter. Such commonly found and used compounds either have little or no residual activities or are rapidly consumed by side reactions. It would be desirable to be able to use such commonly found substances in manner which would provide long-lasting disinfecting and deodorizing properties. Thus, a disinfectant-dosing microgel and method of using the same solving the aforementioned problems are desired.

### SUMMARY

The disinfectant-dosing microgel is formed from a mixture of a sol and a solution of a disinfecting and deodorizing agent. In use, the sol phase is transformed, by various conditions, into an active microgel. The disinfectant-dosing microgel traps disinfecting and deodorizing compounds within a gel network, allowing for their sustained release over time. The sol is formed from a colloidal substance in a dispersion medium, where the colloidal substance has a concentration of 0.1-20.0 wt % of the sol. As a non-limiting example, the dispersion medium may be water, although it should be understood that any other suitable type of liquid medium may be used to form the sol. As a non-limiting example, the solution of the disinfecting and deodorizing agent may be an aqueous solution, although it should be understood that the disinfecting and deodorizing agent may be dissolved in any other suitable solvent. The disinfecting and deodorizing agent has a concentration of 0.1-15.0 wt % of the solution.

As a further non-limiting example, the sol may be a colloidal silica sol, a colloidal alumina sol, or an alginate sol. Additionally, as a non-limiting example, the disinfecting and deodorizing agent may be formed as a mixture of a first component and a second component. The first component may be, as a non-limiting example, sodium chlorite, sodium hypochlorite, potassium peroxymonosulfate, at least one quaternary ammonium compound, zinc nitrate or sodium nitrite. The second component may be, as a non-limiting example, at least one copper nitrate salt or citric acid. In this non-limiting example, the first component and the second component may be in a 1:1 ratio by weight. Alternatively, the first component and the second component may be in a ratio by weight ranging between 1:9 and 9:1.

As an alternative non-limiting example, the disinfecting and deodorizing agent may be copper nitrate, at least one copper nitrate salt, sodium chlorite, at least one nitrate salt, sodium hypochlorite, potassium peroxymonosulfate, at least one quaternary ammonium compound, zinc nitrate, sodium nitrite, thymol, citric acid, or combinations thereof. It should be understood that the disinfecting and deodorizing agent may be any suitable substance for decreasing the viability and activity of microorganisms, further including, but not limited to, peracetic acid, antimicrobial phytochemicals, essential oils, calcium, copper, iron and other metal salts, magnesium, and sodium hydroxide. As a further alternative, the disinfectant-dosing microgel may also include an additional polymer. Non-limiting examples of such polymers include polyvinyl alcohol, carboxymethyl cellulose, and a combination thereof.

In an alternative embodiment, the sol of the disinfectant-dosing microgel, in any of the examples given above, may be replaced by a polymer. Non-limiting examples of such a polymer include polyvinyl alcohol, carboxymethyl cellulose, and a combination thereof. It should be understood that the colloidal sol may be any inorganic, organic, polymeric or biological material that can form a gel network, including, but not limited to, silicas, aluminas, aluminosilicates, carbons, titania, alginate, cellulose, carboxy methylcellulose, polyvinyl alcohol, and silica-polyvinyl alcohol.

In use, the disinfectant-dosing microgel is applied to the waste, such as through, but not limited to, spraying, liquid pumping, direct feed, wetting, mixture and the like. The combination of the sol and the solution of the disinfecting and deodorizing agent or, alternatively, the combination of the polymer and the solution of the disinfecting and deodorizing agent, is triggered to transform from the sol/polymer phase into an active microgel for long-term disinfection and deodorization of the waste by the temperature, pH, and/or salt concentration of the waste. The transformation to the active microgel for long-term disinfection and deodorization of the waste can also be initiated by adding chemical substances to alter the pH or promote gelation, either before, during or after application to the waste. In polymer and inorganic-polymer microgels, these chemical substances may include, as a non-limiting example, cross-linking agents. It should be understood that any suitable type of activating agent may be used, including, but not limited to, acids, bases, chemical cross-linkers and salts. Additionally, the viscosity of the disinfectant-dosing microgel may be adjusted as needed. For example, a low viscosity microgel allows the microgel to percolate and penetrate solid substances, while a highly viscous microgel allows the sol to accumulate on the surface of the solid.

These and other features of the present subject matter will become readily apparent upon further review of the following specification.

### BRIEF DESCRIPTION OF THE DRAWINGS

FIG. 1A is a graph showing disinfection results for both aerobic and anaerobic bacteria in a dewatered sludge sample following treatment with a disinfectant-dosing microgel.

FIG. 1B is a graph showing deodorizing results, based on hydrogen sulfide, for the dewatered sludge sample of FIG. 1A, following treatment with the disinfectant-dosing microgel.

FIG. 2A is a graph showing deodorizing results for a dewatered sludge sample following treatment with a disinfectant-dosing microgel, where the temperature of the dewatered sludge sample triggers transformation from the sol phase into an active microgel.

FIG. 2B is a graph comparing deodorizing results, based on hydrogen sulfide, for the treated dewatered sludge sample of FIG. 2A against an untreated control sample.

FIG. 3A is a graph showing deodorizing results for a raw wet sludge sample following treatment with a disinfectant-dosing microgel, compared against odor results for an untreated control sample of the raw wet sludge.

FIG. 3B is a graph comparing hydrogen sulfide emissions for the treated and untreated sludge samples of FIG. 3A.

Similar reference characters denote corresponding features consistently throughout the attached drawings.

### DETAILED DESCRIPTION OF THE PREFERRED EMBODIMENTS

The disinfectant-dosing microgel is formed from a mixture of a sol and a solution of a disinfecting and deodorizing agent. In use, the sol phase is transformed, by various conditions, into an active microgel. The disinfectant-dosing microgel traps disinfecting and deodorizing compounds within a gel network, allowing for their sustained release over time. The sol is formed from a colloidal substance in a dispersion medium, where the colloidal substance has a concentration of 0.1-20.0 wt % of the sol. As a non-limiting example, the dispersion medium may be water, although it should be understood that any other suitable type of liquid medium may be used to form the sol. As a non-limiting example, the solution of the disinfecting and deodorizing agent may be an aqueous solution, although it should be understood that the disinfecting and deodorizing agent may be dissolved in any other suitable solvent. The disinfecting and deodorizing agent has a concentration of 0.1-15.0 wt % of the solution.

As a further non-limiting example, the sol may be a colloidal silica sol, a colloidal alumina sol, or an alginate sol. Additionally, as a non-limiting example, the disinfecting and deodorizing agent may be formed as a mixture of a first component and a second component. The first component may be, as a non-limiting example, sodium chlorite, sodium hypochlorite, potassium peroxymonosulfate, at least one quaternary ammonium compound, zinc nitrate or sodium nitrite. The second component may be, as a non-limiting example, at least one copper nitrate salt or citric acid. In this non-limiting example, the first component and the second component may be in a 1:1 ratio by weight. Alternatively, the first component and the second component may be in a ratio by weight ranging between 1:9 and 9:1.

As an alternative non-limiting example, the disinfecting and deodorizing agent may be copper nitrate, at least one copper nitrate salt, sodium chlorite, at least one nitrate salt, sodium hypochlorite, potassium peroxymonosulfate, at least one quaternary ammonium compound, zinc nitrate, sodium nitrite, thymol, citric acid, or combinations thereof. It should be understood that the disinfecting and deodorizing agent may be any suitable substance for decreasing the viability and activity of microorganisms, further including, but not limited to, peracetic acid, antimicrobial phytochemicals, essential oils, calcium, copper, iron and other metal salts, magnesium, and sodium hydroxide. As a further alternative, the disinfectant-dosing microgel may also include an additional polymer. Non-limiting examples of such polymers include polyvinyl alcohol, carboxymethyl cellulose, and a combination thereof.

In an alternative embodiment, the sol of the disinfectant-dosing microgel, in any of the examples given above, may be replaced by a polymer. Non-limiting examples of such a polymer include polyvinyl alcohol, carboxymethyl cellulose, and a combination thereof. It should be understood that the colloidal sol may be any inorganic, organic, polymeric or biological material that can form a gel network, including, but not limited to, silicas, aluminas, aluminosilicates, carbons, titania, alginate, cellulose, carboxy methylcellulose, polyvinyl alcohol, and silica-polyvinyl alcohol.

In use, the disinfectant-dosing microgel is applied to the waste, such as through, but not limited to, spraying, liquid pumping, direct feed, wetting, mixture and the like. The combination of the sol and the solution of the disinfecting and deodorizing agent or, alternatively, the combination of the polymer and the solution of the disinfecting and deodorizing agent, is triggered to transform the microgel from the sol/polymer phase into an active microgel for long-term disinfection and deodorization of the waste by the temperature, pH, and/or salt concentration of the waste. The transformation to the active microgel for long-term disinfection and deodorization of the waste can also be initiated by adding chemical substances to alter the pH or promote gelation, either before, during or after application to the waste. In polymer and inorganic-polymer microgels, these chemical substances may include, as a non-limiting example, cross-linking agents. It should be understood that any suitable type of activating agent may be used, including, but not limited to, acids, bases, chemical cross-linkers and salts. Additionally, the viscosity of the disinfectant-dosing microgel may be adjusted as needed. For example, a low viscosity microgel allows the microgel to percolate and penetrate solid substances, while a highly viscous microgel allows the sol to accumulate on the surface of the solid.

### Example 1

Disinfectant-dosing microgel formulations including colloidal silica, active ingredients, and a water dispersant were prepared as described above. The concentration of colloidal silica in water can be varied from 0.1 to 20.0 wt %. The active ingredients include disinfectants and deodorizing compounds, such as mixtures of sodium chlorite and copper salt, and are added in amount of 0.1 to 15 wt %. The concentrations of individual active ingredients can be adjusted from 1:9 to 9:1 mass ratio as needed.

### Example 2

A disinfectant-dosing microgel was prepared as described in Example 1, with 20.0 wt % colloidal silica sol mixed with 8 wt % active ingredients. The active ingredients were sodium chlorite and copper nitrate salts in a 9:1 mass ratio.

### Example 3

A disinfectant-dosing microgel was prepared as described in Example 1, with 5.0 wt % colloidal silica sol mixed with 8 wt % active ingredients. The active ingredients were sodium chlorite and copper nitrate salts in a 9:1 mass ratio.

### Example 4

A disinfectant-dosing microgel was prepared as described in Example 1, with 0.5 wt % colloidal silica sol mixed with 8 wt % active ingredients. The active ingredients were sodium chlorite and copper nitrate salts in a 9:1 mass ratio.

### Example 5

A disinfectant-dosing microgel was prepared as described in Example 1, with 0.5 wt % colloidal silica sol mixed with 8 wt % active ingredients. The active ingredients were sodium chlorite and copper chloride salts in a 9:1 mass ratio.

### Example 6

A disinfectant-dosing microgel was prepared as described in Example 1, with 0.5 wt % colloidal silica sol mixed with 1 wt % copper nitrate and 1 wt % copper chloride salts.

### Example 7

A disinfectant-dosing microgel was prepared as described in Example 1, with 0.1 wt % colloidal silica sol mixed with 3 wt % active ingredients. The active ingredients were sodium chlorite and copper nitrate salts in a 1:9 mass ratio.

### Example 8

A disinfectant-dosing microgel was prepared as described in Example 1, with 0.1 wt % colloidal silica sol mixed with 0.1 wt % sodium chlorite, 2.7 wt % copper nitrate, and 0.3 wt % ascorbic acid.

### Example 9

A disinfectant-dosing microgel was prepared as described in Example 1, with 0.1 wt % colloidal silica sol mixed with 2.5 wt % sodium chlorite and 0.5 wt % citric acid.

### Example 10

A disinfectant-dosing microgel was prepared as described in Example 1, with 0.1 wt % colloidal silica sol mixed with 0.1 wt % sodium chlorite, and 2.7 wt % copper nitrate and copper chloride salts.

### Example 11

Disinfectant-dosing microgel formulations including colloidal silica, active ingredients, and a water dispersant were prepared as described above. The concentration of colloidal silica in water can be varied from 0.1 to 25 wt %. The active ingredients, in an amount ranging from 0.1 to 8.0 wt %, included sodium chlorite and a mixture of carboxylic acids.

### Example 12

A disinfectant-dosing microgel was prepared as described in Example 11, with 5 wt % colloidal silica sol mixed with 5 wt % sodium chlorite and 0.5 wt % carboxylic acids (e.g., citric, oxalic, and maleic acids).

### Example 13

A disinfectant-dosing microgel was prepared as described in Example 11, with 0.5 wt % colloidal silica sol mixed with 5 wt % sodium chlorite and 0.5 wt % carboxylic acids (e.g., citric, oxalic, and maleic acids).

### Example 14

A disinfectant-dosing microgel was prepared as described in Example 11, with 0.5 wt % colloidal silica sol mixed with 2.5 wt % sodium chlorite and 0.5 wt % carboxylic acids (e.g., citric, oxalic, maleic acids).

### Example 15

A disinfectant-dosing microgel was prepared as described in Example 11, with 0.1 wt % colloidal silica sol mixed with 2.5 wt % sodium chlorite and 0.5 wt % carboxylic acids (e.g., citric, oxalic, maleic acids).

### Example 16

Disinfectant-dosing microgel formulations including colloidal silica, active ingredients, and a water dispersant were prepared. The concentration of colloidal silica in water can be varied from 0.1 to 20.0 wt %. The active ingredients included 0.1 to 8.0 wt % metal salts.

### Example 17

A disinfectant-dosing microgel was prepared as described in Example 16, with 10 wt % colloidal silica sol mixed with 1 wt % copper nitrate and 0.5 wt % zinc chloride.

### Example 18

A disinfectant-dosing microgel was prepared as described in Example 16, with 1 wt % colloidal silica sol mixed with 0.5 wt % copper nitrate and 0.5 wt % zinc chloride.

### Example 19

A disinfectant-dosing microgel was prepared as described in Example 16, with 0.1 wt % colloidal silica sol mixed with 2.5 wt % copper nitrate and 0.5 wt % zinc chloride.

### Example 20

A disinfectant-dosing microgel was prepared as described in Example 16, with 0.5 wt % colloidal silica sol mixed with 0.2 wt % iron chloride, 0.5 wt % zinc chloride, and 0.1 wt % copper chloride.

### Example 21

A disinfectant-dosing microgel was prepared as described in Example 16, with 0.5 wt % colloidal silica sol mixed with 1 wt % iron salt and 0.5 wt % calcium salt.

### Example 22

Disinfectant-dosing microgel formulations including colloidal silica, active ingredients, and a water dispersant were prepared. The concentration of colloidal silica in water can be varied from 0.1 to 20.0 wt %. The active ingredients included disinfectants and deodorizing compounds, such as mixtures of sodium hypochlorite and copper salt, and were added in an amount of 0.1 to 15 wt %. The concentrations of individual active ingredients can be adjusted from 1:9 to 9:1 mass ratio, as needed.

### Example 23

A disinfectant-dosing microgel was prepared as described in Example 22, with 10 wt % colloidal silica sol mixed with 2 wt % sodium hypophosphite and 0.5 wt % copper nitrate.

### Example 24

A disinfectant-dosing microgel was prepared as described in Example 22, with 0.5 wt % colloidal silica sol mixed with 2 wt % sodium hypophosphite and 0.5 wt % copper nitrate.

### Example 25

A disinfectant-dosing microgel was prepared as described in Example 22, with 10 wt % colloidal silica sol mixed with 0.5 to 5 wt % sodium hypophosphite.

### Example 26

A disinfectant-dosing microgel was prepared as described in Example 22, with 1 wt % colloidal silica sol mixed with 0.5 to 5 wt % sodium hypophosphite.

### Example 27

A disinfectant-dosing microgel was prepared as described in Example 22, with 0.5 wt % colloidal silica sol mixed with 2 wt % sodium hypophosphite, 0.3 wt % copper nitrate, and 0.3 wt % zinc chloride.

### Example 28

Disinfectant-dosing microgel formulations including colloidal silica, active ingredients, and a water dispersant were prepared. The concentration of colloidal silica in water can be varied from 0.1 to 20.0 wt %. The active ingredients included disinfectants and deodorizing compounds, such as mixtures of potassium peroxymonosulfate and copper salts, and were added in an amount of 0.1 to 15 wt %. The concentrations of individual active ingredients can be adjusted from 1:9 to 9:1 mass ratio, as needed.

### Example 29

A disinfectant-dosing microgel was prepared as described in Example 28, with 5 wt % colloidal silica sol mixed with 2 wt % potassium peroxymonosulfate and 0.5 wt % copper nitrate.

### Example 30

A disinfectant-dosing microgel was prepared as described in Example 28, with 0.5 wt % colloidal silica sol mixed with 1 wt % potassium peroxymonosulfate and 1.5 wt % copper nitrate.

### Example 31

A disinfectant-dosing microgel was prepared as described in Example 28, with 0.5 wt % colloidal silica sol mixed with 1 wt % potassium peroxymonosulfate and 0.5 wt % iron chloride.

### Example 32

A disinfectant-dosing microgel was prepared as described in Example 28, with 0.5 wt % colloidal silica sol mixed with 1 wt % potassium peroxymonosulfate, 0.5 wt % sodium chlorite, and 0.5 wt % copper nitrate.

### Example 33

Disinfectant-dosing microgel formulations including colloidal silica, active ingredients, and a water dispersant were prepared. The concentration of colloidal silica in water can be varied from 0.1 to 20.0 wt %. The active ingredients included disinfectants and deodorizing compounds, such as mixtures of potassium peroxymonosulfate and sodium chlorite, and were added in an amount of 0.1 to 15 wt %. The concentrations of individual active ingredients can be adjusted from 1:9 to 9:1 mass ratio, as needed.

### Example 34

A disinfectant-dosing microgel was prepared as described in Example 33, with 10 wt % colloidal silica sol mixed with 1 wt % potassium peroxymonosulfate and 0.5 wt % sodium chlorite.

### Example 35

A disinfectant-dosing microgel was prepared as described in Example 33, with 0.5 wt % colloidal silica sol mixed with 1 wt % potassium peroxymonosulfate and 0.5 wt % sodium chlorite.

### Example 36

A disinfectant-dosing microgel was prepared as described in Example 33, with 0.5 wt % colloidal silica sol mixed with 0.5 to 10 wt % potassium peroxymonosulfate.

### Example 37

Disinfectant-dosing microgel formulations including colloidal silica, active ingredients, and a water dispersant were prepared. The concentration of colloidal silica in water can be varied from 0.1 to 20.0 wt %. The active ingredients included disinfectants and deodorizing compounds, such as mixtures of quaternary ammonium and copper salts, and were added in an amount of 0.1 to 15 wt %. The concentrations of individual active ingredients can be adjusted from 1:9 to 9:1 mass ratio, as needed.

### Example 38

A disinfectant-dosing microgel was prepared as described in Example 37, with 5 wt % colloidal silica sol mixed with 4 wt % quaternary ammonium chloride and 4 wt % copper nitrate salts.

### Example 39

A disinfectant-dosing microgel was prepared as described in Example 37, with 0.5 wt % colloidal silica sol mixed with 3 wt % quaternary ammonium chloride and 2 wt % copper nitrate salts.

### Example 40

A disinfectant-dosing microgel was prepared as described in Example 37, with 0.5 wt % colloidal silica sol mixed with 3 wt % quaternary ammonium chloride and 2 wt % copper chloride salts.

### Example 41

Disinfectant-dosing microgel formulations including colloidal silica, active ingredients, and a water dispersant were prepared. The concentration of colloidal silica in water can be varied from 0.1 to 20.0 wt %. The active ingredients included a mixture of quaternary ammonium compounds, which was added in an amount of 0.1 to 15 wt %.

### Example 42

Disinfectant-dosing microgel formulations including colloidal silica, active ingredients, and a water dispersant were prepared. The concentration of colloidal silica in water can be varied from 0.1 to 20.0 wt %. The active ingredients included a mixture of metal oxides and metal salts, which was added in an amount of 0.1 to 20 wt %.

### Example 43

A disinfectant-dosing microgel was prepared as described in Example 42, with 5 wt % colloidal silica sol mixed with 2.5 wt % copper oxides and 2.5 wt % copper nitrate.

### Example 44

A disinfectant-dosing microgel was prepared as described in Example 42, with 5 wt % colloidal silica sol mixed with 2.5 wt % copper oxides and 2.5 wt % zinc chloride.

### Example 45

A disinfectant-dosing microgel was prepared as described in Example 42, with 5 wt % colloidal silica sol mixed with 2.5 wt % copper oxides and 2.5 wt % iron chloride.

### Example 46

A disinfectant-dosing microgel was prepared as described in Example 42, with 5 wt % colloidal silica sol mixed with 2.5 wt % copper oxides and 1.5 wt % sodium chlorite.

### Example 47

A disinfectant-dosing microgel was prepared as described in Example 42, with 5 wt % colloidal silica sol mixed with 2.5 wt % zinc oxides and 2.5 wt % copper nitrate.

### Example 48

Disinfectant-dosing microgel formulations including colloidal silica, active ingredients, and a water dispersant were prepared. The concentration of colloidal silica in water can be varied from 0.1 to 20.0 wt %. The active ingredients included mixtures of sodium nitrite and metal salts, and were added in an amount of 0.1 to 20 wt %. The concentrations of individual active ingredients can be adjusted from 1:9 to 9:1 mass ratio, as needed.

### Example 49

A disinfectant-dosing microgel was prepared as described in Example 48, with 5 wt % colloidal silica sol mixed with 0.5 wt % sodium nitrite and 2.5 wt % copper nitrate.

### Example 50

A disinfectant-dosing microgel was prepared as described in Example 48, with 5 wt % colloidal silica sol mixed with 0.5 wt % sodium nitrite and 2.5 wt % zinc chloride.

### Example 51

A disinfectant-dosing microgel was prepared as described in Example 48, with 0.5 wt % colloidal silica sol mixed with 0.5 wt % sodium nitrite and 0.5 wt % copper nitrate.

### Example 52

A disinfectant-dosing microgel was prepared as described in Example 48, with 20 wt % colloidal silica sol mixed with 1.0 wt % sodium nitrite and 2.5 wt % copper nitrate.

### Example 53

A disinfectant-dosing microgel was prepared as described in Example 48, with 5 wt % colloidal silica sol mixed with 0.5 wt % sodium nitrite, 1.0 wt % copper nitrate, and 0.5 wt % zinc chloride.

### Example 54

A disinfectant-dosing microgel was prepared as described in Example 48, with 20 wt % colloidal silica sol mixed with 1.0 wt % sodium nitrite and 2.5 wt % zinc chloride.

### Example 55

Disinfectant-dosing microgel formulations including colloidal silica, active ingredients, and a water dispersant were prepared. The concentration of colloidal silica in water can be varied from 0.1 to 20.0 wt %. The active ingredient included sodium nitrite, and was added in an amount of 0.1 to 20 wt %.

### Example 56

Disinfectant-dosing microgel formulations including colloidal silica, active ingredients, and a water dispersant were prepared. The concentration of colloidal silica in water can be varied from 0.5 to 5.0 wt %. The active ingredients included mixtures of sodium chlorite, zinc nitrate, and copper nitrate salts, and were added in an amount of 0.1 to 20 wt %. The proportion of sodium chlorite, zinc nitrate, and copper nitrate salts was adjusted, dependent upon intended application.

### Example 57

Disinfectant-dosing microgels were prepared as described in Examples 1-56, but with the colloidal silica sol replaced with a colloidal alumina sol.

### Example 58

Disinfectant-dosing microgels were prepared as described in Examples 1-56, but with the colloidal silica sol replaced with alginate.

### Example 59

Disinfectant-dosing microgels were prepared as described in Examples 1-56, but with the colloidal silica sol replaced with a polymer, including polyvinyl alcohol, carboxymethyl cellulose, and a combination thereof.

### Example 60

Disinfectant-dosing microgels were prepared as described in Examples 1-56, but with the addition of a polymer, including polyvinyl alcohol, carboxymethyl cellulose, and a combination thereof.

### Example 61

Disinfectant-dosing microgels were prepared as described in Examples 1-56, but with the colloidal silica replaced with other inorganic oxides that can form a sol-gel, such as, but not limited to, titania, copper oxide, and zinc oxide.

### Example 62

Disinfectant-dosing microgels were prepared as described in Examples 1-56, but with the addition of second or third inorganic oxides that can form a sol-gel with silica, such as, but not limited to, silica-titania, silica-alumina, and silica-zirconia.

### Example 63

Disinfectant-dosing microgels, prepared as described above, were added to samples of an odorous waste substance, and transformation from the sol phase into the active microgels for long-term disinfection and deodorization was triggered by temperature, pH, and/or salt concentration in the odorous waste substance samples. The activating transformation was also initiated by adding chemical substances to alter the pH and/or promote gelation before, during or after addition to the odorous waste substance. In both polymer and inorganic-polymer systems, these chemical substances include cross-linking agents.

### Example 64

The viscosities of disinfectant-dosing microgels, prepared as described above, were adjusted, dependent upon intended application. Low viscosity microgels can percolate and penetrate solid substances, and high viscosity microgels accumulate on the surfaces of solids.

### Example 65

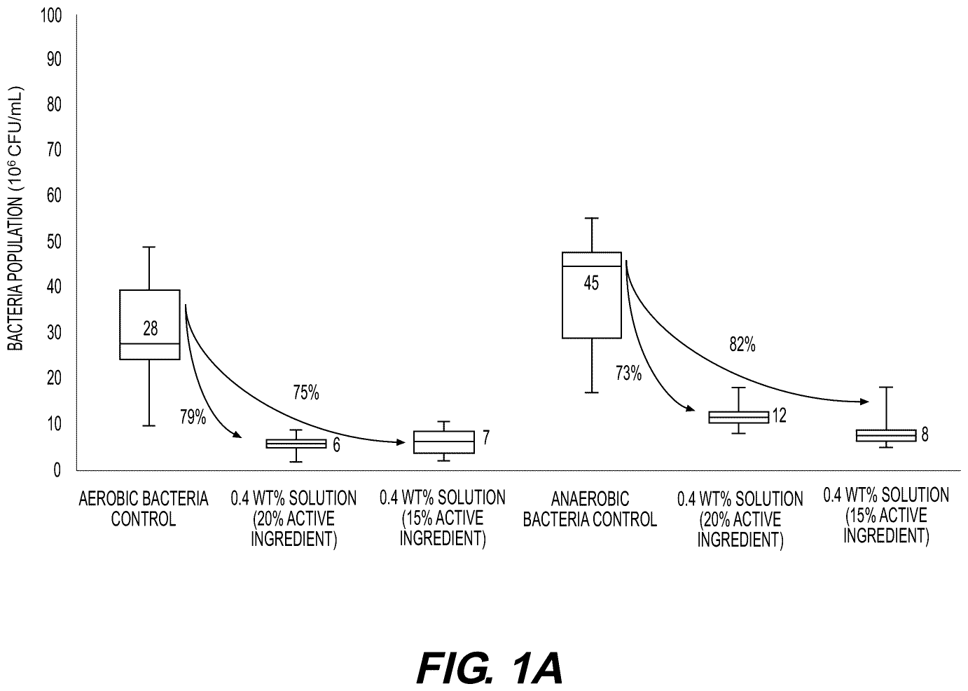

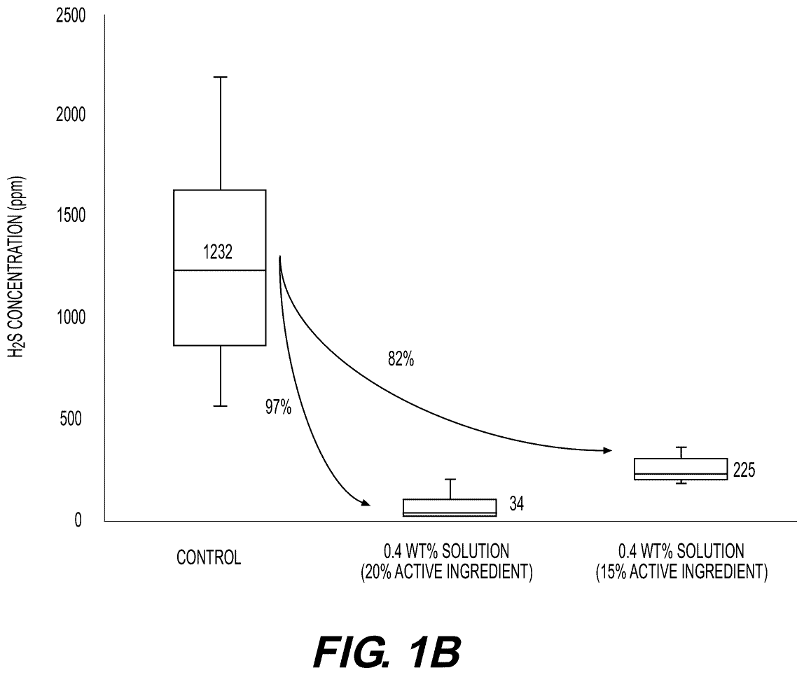

A diluted disinfectant-dosing microgel, containing 9 wt % zinc nitrate salts, 8 wt % copper nitrate salts and 0.5 wt % colloidal silica sol, was added to 30 kg of dewatered sludge from a chemically enhanced primary treatment (CEPT) process at the Stonecutters Island Sewage Treatment Works (SCISTW) in Hong Kong. The disinfectant-dosing microgel rapidly disinfected the aerobic (75%-79% decrease) and anaerobic (73%-82% decrease) bacteria in the dewatered sludge, as shown in FIG. 1A, and deodorized the dewatered sludge of hydrogen sulfide by 82%-97%, as presented in FIG. 1B. 120 g of the diluted disinfectant-dosing microgel was added to the 30 kg of dewatered CEPT sludge in a 60 L container, giving a 0.4 wt % loading.

### Example 66

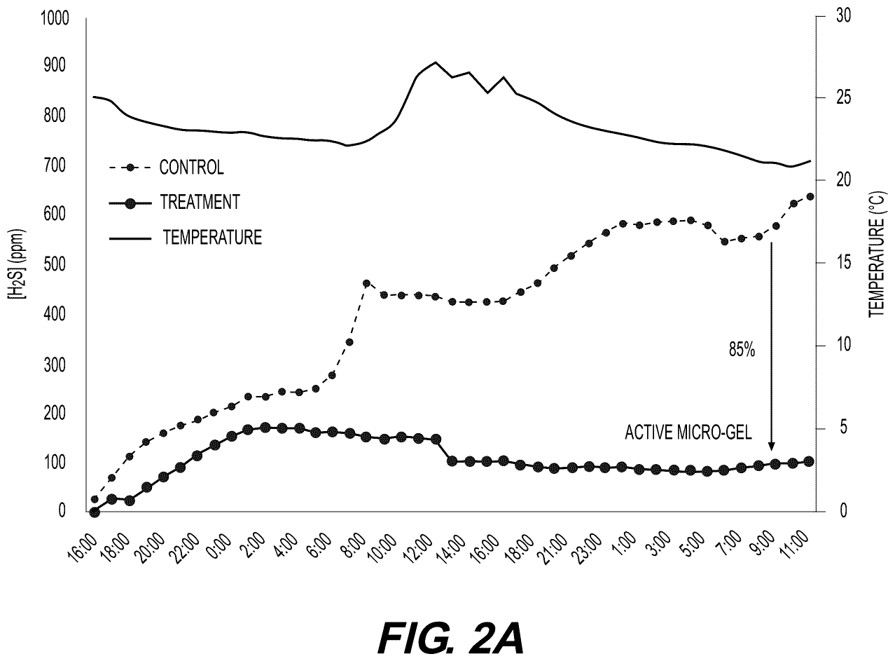

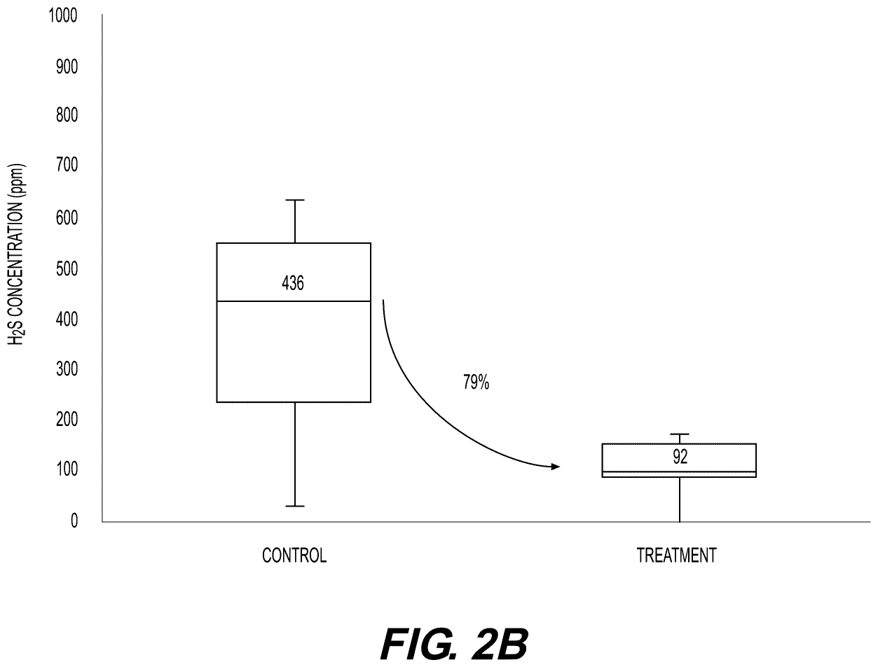

52 kg of a diluted disinfectant-dosing microgel, containing 15.0 wt % disinfecting and deodorizing compounds, was sprayed onto 13 tons of dewatered CEPT (10.4 wt % loading) sludge in a truck container. FIG. 2A shows the temperature-triggered activation of the sol phase into the active microgel, which provided long-term odor suppression (˜85% decrease in H₂S) in 13 tons of dewatered CEPT sludge in truck containers. A rise in temperature increased microbial activity, thus generating more odorous gases in the untreated sludge. The same rise in temperature triggered the formation of active microgel from the sol phase, enabling a dosing of the disinfecting and deodorizing compounds over an extended time, resulting in a large overall decrease in the malodorous hydrogen sulfide when compared to untreated sludge, as shown in FIG. 2B.

### Example 67

A viscous disinfectant-dosing microgel formed from 10.0 wt % colloidal silica sol and 8.0 wt % disinfecting and deodorizing compounds, which included sodium chlorite, thymol, zinc nitrate, copper nitrate and citric acid, was sprayed onto dewatered CEPT sludge to form a gel-in-place layer on the surface of the sludge. This layer on the surface both disinfected and deodorized the sample, as well as preventing odorous gases from escaping to cause an environmental odor problem.

### Example 68

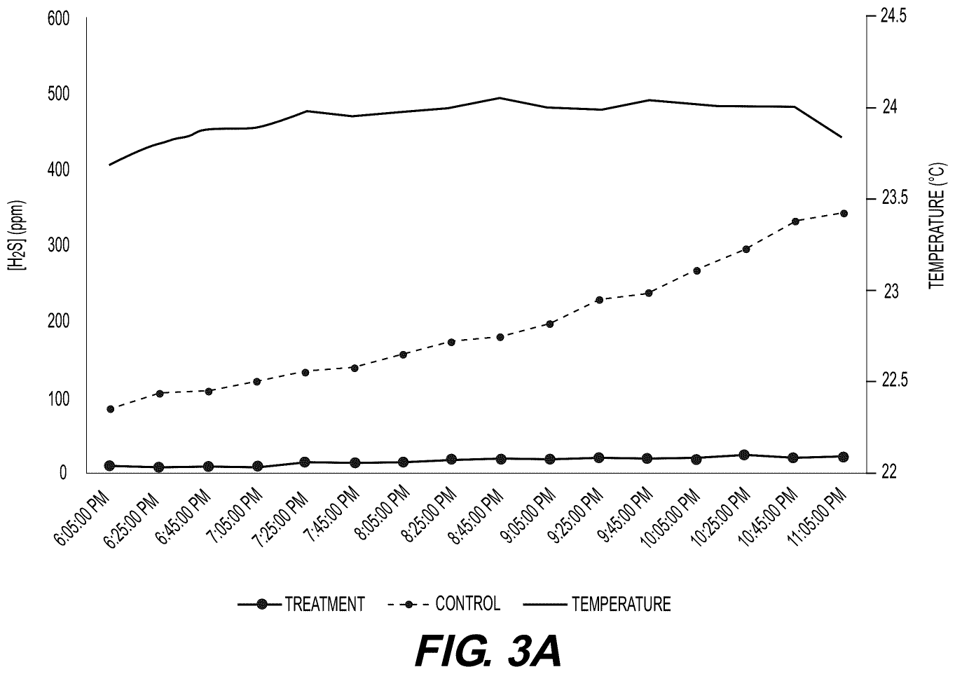

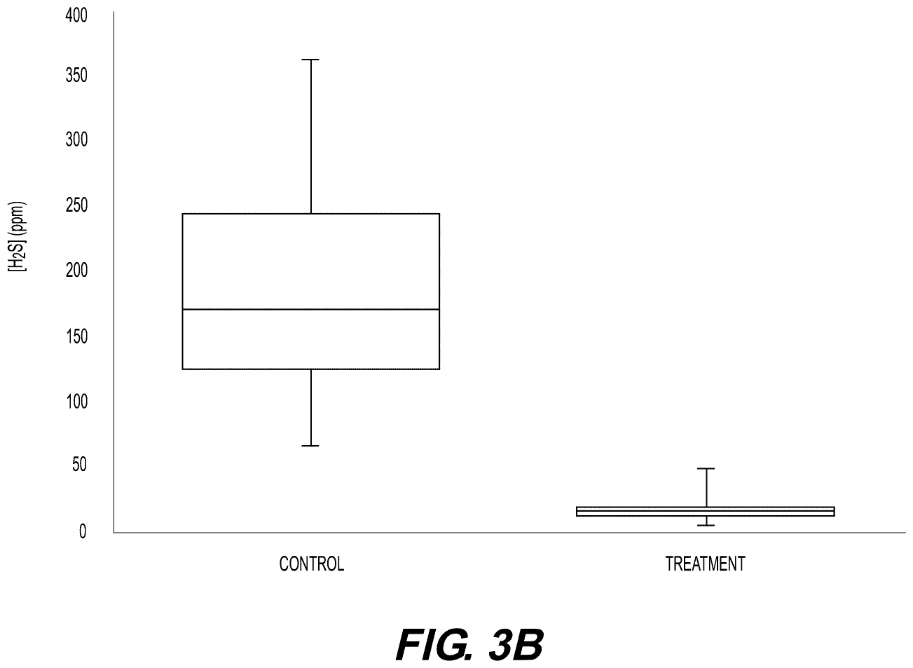

A disinfectant-dosing microgel was transformed from the sol phase into an active microgel through addition of an acid, prior to adding the active microgel to 250 L of raw wet sludge. The total amount added was 25 g, giving a 0.01 wt % loading. FIG. 3A shows the H₂S profiles (time-weighted-value/average data per 20 minutes) for both untreated and treated wet sludge. As shown in FIGS. 3A and 3B, the active microgel provides effective and long-term odor suppression and high overall H₂S suppression. The 0.01 wt % loading of the active microgel contained 20 wt % active disinfecting and deodorizing compounds.

It is to be understood that the disinfectant-dosing microgel and method of using the same is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A method of disinfecting and deodorizing waste, comprising the step of applying a disinfectant-dosing microgel to waste,
wherein the disinfectant-dosing microgel comprises:
a first component; and
a second component comprising a solution of a disinfecting and deodorizing agent, wherein the disinfecting and deodorizing agent has a concentration of 0.1-15.0 wt % of the solution.

2. The method of disinfecting and deodorizing waste as recited in claim 1, wherein the first component comprises a sol comprising a colloidal substance in a dispersion medium, wherein the colloidal substance has a concentration of 0.1-20.0 wt % of the sol.

3. The method of disinfecting and deodorizing waste as recited in claim 1, wherein the first component comprises a polymer selected from the group consisting of polyvinyl alcohol, carboxymethyl cellulose, and a combination thereof.

4. The method of disinfecting and deodorizing waste as recited in claim 1, wherein the disinfecting and deodorizing agent comprises a mixture of a first component and a second component,
wherein the first component is selected from the group consisting of sodium chlorite, sodium hypochlorite, potassium peroxymonosulfate, at least one quaternary ammonium compound, zinc nitrate and sodium nitrite, and
wherein the second component is selected from the group consisting of at least one copper nitrate salt and citric acid.

5. The method of disinfecting and deodorizing waste as recited in claim 4, wherein the first component and the second component are in a 1:1 ratio by weight.

6. The method of disinfecting and deodorizing waste as recited in claim 4, wherein the first component and the second component are in a ratio by weight between 1:9 and 9:1.

7. The method of disinfecting and deodorizing waste as recited in claim 1, wherein the disinfecting and deodorizing agent is selected from the group consisting of copper nitrate, at least one copper nitrate salt, sodium chlorite, at least one nitrite salt, sodium hypochlorite, potassium peroxymonosulfate, at least one quaternary ammonium compound, zinc nitrate, sodium nitrite, thymol, citric acid and combinations thereof.
